(19) United States
(12) Patent Application Publication
(10) Pub. No.: US 2006/0254175 A1
(43) Pub. Date: Nov. 16, 2006

(54) Modular plastic cabinet door and drawer front

(76) Inventor: Warren H. Thun, Hewlett, NY (US)

Correspondence Address: Donald W. Marks, 3137 Mount Vernon Avenue, Alexandria, VA, 22305, US

(21) Appl. No.: 11/105,436

(22) Filed: Apr. 14, 2005

(51) Int. Cl. E06B 3/70

(52) U.S. Cl. 52/455

(57) ABSTRACT

A modular plastic cabinet door has a frame formed by left and right side frame members 30 and 32 cut from a first extruded plastic strip, top and bottom frame members 34 and 36 cut from a second extruded plastic strip, and a plurality of vertical center members 40, 42, 44 and 46 cut from third and fourth extruded plastic strips. The left and right side frame members have opposite orientation and extend the full vertical height of the door with inner facing surfaces having dovetail grooves 52 formed therein. The top and bottom frame members have opposite orientation with end edges having dovetails 62 fit into the respective upper and lower ends of the dovetail grooves in the side frame members and have inner facing surfaces with grooves 58 formed therein equal in width to the dovetail grooves. The vertical center members have a thickness equal to the width of the frame member grooves, have upper and lower ends fit into the grooves of the top and bottom members and have vertical edges with tongues and grooves fitting with each other. Left and right edge center members of said vertical center members have respective edge portions fit into center portions of the dovetail grooves in the side frame members.

### BACKGROUND OF THE INVENTION

Many cabinet doors are conventionally made from single panel wood or laminated materials or made from wood frames, usually with mitered corner junctions, in which center panels are secured. Molded or extruded plastic materials are sometimes used.

### BRIEF SUMMARY OF THE INVENTION

It is an object of the invention to provide a cabinet door which can be formed from a few, as few as three, standard extruded plastic strip-like members with a minimum of milling and assembly.

The invention is summarized in a modular plastic cabinet door having a frame formed by left and right side frame members cut from a first extruded plastic strip, top and bottom frame members cut from a second extruded plastic strip, and a plurality of vertical center members cut from a third and possibly a fourth extruded plastic strip. The left and right side frame members have opposite orientation and extend the full vertical height of the door with inner facing surfaces having dovetail grooves formed therein. The top and bottom frame members have opposite orientation with end edges having dovetails fit into the respective upper and lower ends of the dovetail grooves in the side frame members and have inner facing surfaces with grooves formed therein equal in width to the dovetail grooves. The vertical center members have a thickness equal to the width of the frame member grooves. have upper and lower ends fit into the grooves of the top and bottom members and have vertical edges with tongues and grooves fitting with each other. Left and right edge center members of said vertical center members have respective edge portions fit into center portions of the dovetail grooves in the side frame members.

An advantage of the invention is that, after cutting the door members in proper lengths from the three or four extruded plastic strips, only the dovetails need to be milled or machined on the ends of the top and bottom frame members before completing the assembly of the door.

Another advantage of the invention is that different widths of doors are formed by including different numbers of the vertical center members. By including vertical center members cut from a fourth extruded plastic strip of different width from the third extruded plastic strip, further different door widths are possible.

Another aspect of the invention is to provide a V-shaped groove in a surface of the dovetail grooves in the left and right frame members and to then provide metal barb or screw members in the V-shaped grooves at the upper and lower ends to secure the dovetails in the dovetail grooves.

In a further invention metal barb members for securing dovetail joints are tubular members with cutouts in the wall forming triangular barbs bent inward and pointed tips on the barbs bent outward for penetrating the surfaces of the dovetail and dovetail groove when a member is inserted in the tubular member to bend the barbs outward.

Other objects, advantages and features of the invention will be apparent from the following detailed description of the invention taken in conjunction with the accompanying drawings.

### BRIEF DESCRIPTION OF THE DRAWINGS

FIG. 1 is a perspective view of a cabinet door constructed in accordance with the present invention.

FIG. 2 is a perspective view of a drawer front constructed in accordance with the present invention.

FIG. 3 is a cross section view of a first extruded plastic strip which can be cut in desired lengths according to the desired door height to form left and right door frame members.

FIG. 4 is a cross section view of a second extruded plastic strip which can be cut in desired lengths to form top and bottom door frame members.

FIG. 5 is a cross section view showing the dovetail joint between a side frame member and a broken-away end portion of a top or bottom frame member.

FIG. 6 is an end view of two assembled vertical center members cut from respective third and fourth extruded plastic strips.

FIG. 7 is a cross section view of the assembly of a left side vertical center member and a left side frame member.

FIG. 8 is a cross section view of the assembly of a right side vertical center member and a right side frame member.

FIG. 9 is a side view of an assembled broken-away upper end of a vertical center member in a groove in a top or bottom frame member.

FIG. 10 is an enlarged cross section view of a broken-away portion showing the junction between the members of FIG. 9.

FIG. 11 is a plan view of a punched metal sheet member used to form a barb member.

FIG. 12 is a side view of the punched metal sheet member of FIG. 11

FIG. 13 is a perspective view of a broken-away upper portion of the barb member formed from the punched metal sheet member of FIGS. 11 and 12.

FIG. 14 is a cross section view of the barb member of FIG. 12 inserted in an enlarged broken-away portion of the dovetail and dovetail groove junction of FIG. 5.

FIG. 15 is an enlarged broken-away portion of a modified junction between a side vertical center member and a side frame member.

FIG. 16 is a cross section view of a fifth extruded plastic strip from which a center panel of the drawer front of FIG. 2 can be cut.

FIG. 17 is perspective view of broken-away portions of a dovetail and dovetail groove showing a screw serving as a modified barb member securing the dovetail in the dovetail groove.

FIG. 18 is an enlarged section view of a broken away portion of another variation of the union between a side frame member and a center member.

FIG. 19 is an enlarged section view similar to FIG. 18 but of still another variation of the union between a side frame member and a center member.

FIG. 20 is a further enlarged section view of a broken away portion similar to FIG. 18 but of a further variation of the union between a side member and a center member.

FIG. 21 is a view similar to FIG. 20 but of a still further variation.

FIG. 22 is end view of a modified extruded strip for forming side frame members.

FIG. 23 is an end view of a modified extruded strip of forming top and bottom frame members.

### DETAILED DESCRIPTION OF THE INVENTION

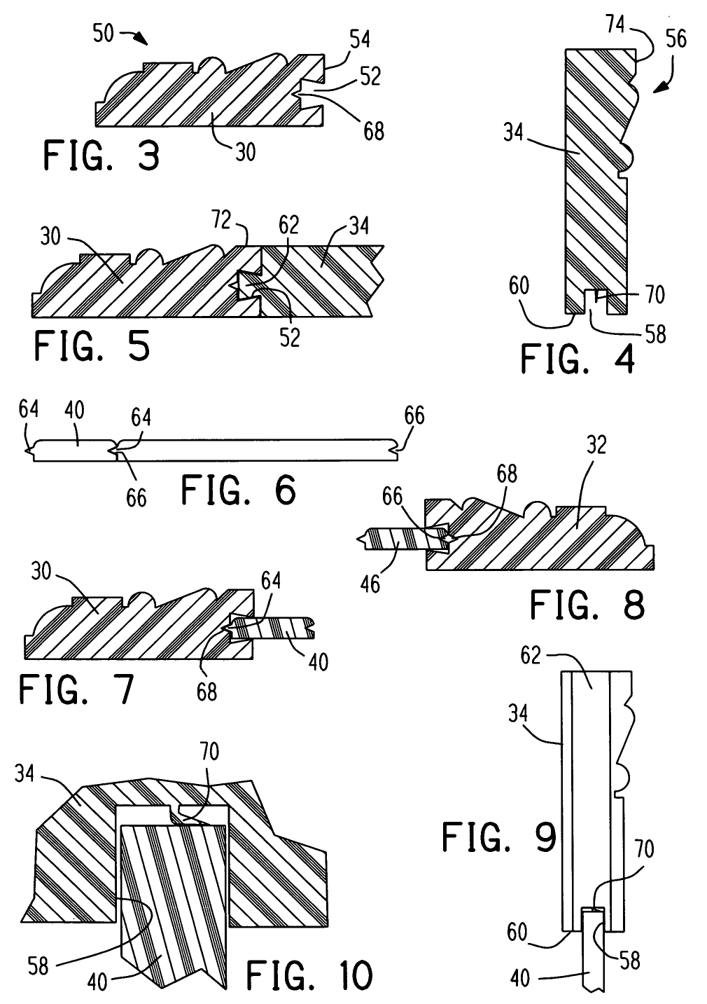

As shown in FIG. 1, a cabinet door in accordance with the invention includes a frame formed by left side member 30, right side member 32, top frame member 34 and bottom frame member 36 along with a plurality of vertical center members such as members 40, 42, 44 and 46. The left and right side frame members 30 and 32 are oppositely oriented cut lengths of a first extruded plastic strip which as shown in FIG. 3 has a decorative contoured front face 50 and a dovetail groove 52 formed in an inner facing edge 54. The top and bottom frame members 34 and 36 are oppositely oriented cut lengths of a second extruded plastic strip which as shown in FIG. 4 has a decorative contoured front face 56 and a groove 58 formed in an inward facing edge 60. The outer vertical center members 40 and 46 are cut lengths of a third extruded plastic strip while the inner vertical center members 42 and 44 are cut from a fourth extruded plastic strip; the third and fourth plastic strips have similar thickness but different widths. Left and right ends of the top and bottom members, as shown in FIG. 5 for the left end of the top member 34, are machined to form dovetails 62 which are fit in the upper and lower ends of the dovetail grooves 52 of the left and right side frame members to secure the frame members 30, 32, 34 and 36 in a rectangular frame configuration. Upper and lower ends of the center members 40, 42, 44 and 46 are captured in the grooves 58 of the top and bottom frame members as shown for the top frame member 34 and the center member 40 in FIGS. 9 and 10. As shown in FIGS. 7 and 8, the outer edges of the left and right center members 40 and 46 are captured in the center portions of the dovetail grooves 52 of the left and right frame members 30 and 32. The center members 40, 42, 44 and 46 as shown for the members 40 and 42 in FIG. 6 have tongues 64 and grooves 66 formed on opposite sides; the tongues 64 are designed to mate with grooves 66 formed in an adjoining center member. Although the center members 42 and 44 are shown as being substantially wider than the center members 40 and 46, the center members 40, 42, 44 and 46 could all be the same width or various widths. Also there could be only one, two or three center members or more than four center members of the same width or different widths.

The side members 30 and 32 are cut from the first extruded plastic strip with a length equal to the desired height of the door. The top and bottom members 34 and 36 are cut from the second extruded plastic strip with a length equal to the desired width of the door minus the width of the side frame members and plus the desired height (horizontal dimension as shown in FIG. 5) of the dovetails 62. The only milling which is required is the machining of the ends of the top and bottom frame members 34 and 36 to form the dovetails 62. The center members 40, 42, 44 and 46 are cut from the respective third and fourth extruded plastic strips in a length equal to the desired height of the door minus the width of the top and bottom frame members and plus an allowance for fitting the ends of the center members in the grooves 58. The number of center members 40, 42, 44 and 46 and their widths are selected to form an assembly of center members having a width (horizontal dimension shown in FIG. 6) which corresponds to the desired width of the door minus the width of the side frame members 30 and 32 and plus an allowance for the edges of the outer center members extending into the dovetail grooves of the side frame members.

In assembly, the side frame members 30 and 32 are first assembled on one of the top or bottom frame members 34 or 36 by sliding the dovetails 62 of the one member 34 or 36 into the corresponding upper and lower end portions of the dovetail grooves 52 in the side flame members leaving the other of the top or bottom ends of the frame open Then the center members 40, 42, 44 and 46 are assembled through the open end of the frame with corresponding ends of the center members fitted into groove 58 in the assembled one frame member and into the dovetail grooves of the side frame members with the tongues 64 of center members assembled into the grooves 66 in adjoining center members. Finally the unassembled other top or bottom frame member is assembled by sliding the dovetails 62 of this other frame member into the corresponding end portions of the dovetail grooves in side frame members and to fit the exposed ends of the center members into the groove 58 of the top or bottom frame member being assembled to complete the assembly of the door. With only the milling of the dovetails on the ends of the top and bottom frame members, milling in forming the cabinet door is minimized to reduce labor costs.

In the variation illustrated in FIGS. 6, 7 and 8, the tongues 64 and grooves 66 in the sides of the center members have mating V-shaped cross sections. Also as shown in FIGS. 3 and 7, the bottom surface of the dovetail groove 52 optionally has a further groove 68 formed therein so that in one side frame member 30 the groove 68 mates with the tongue 64 of one outer center member 40; in the other side frame member 32 as shown in FIG. 8, the grooves 66 and 68 of the corresponding other outer center member 46 and other side frame member 32 form a void. In further variations these tongues and grooves on the side edges of the center members could alternatively have mating square or rectangular cross sections such as shown in FIG. 18 for tongues 64′ and grooves 66′ or mating rounded cross sections as shown in FIG. 19 for tongues 64″ and grooves 66″. With the rectangular or rounded tongues formed on one side edge of the center members, corresponding rectangular grooves 68′ or rounded grooves 68″ are formed in the bottom of the dovetail slot in the side frame members 30 and 32.

It is advantageous that the cabinet door in accordance with the invention is made from only three or four or more extruded plastic strips. Use of only three extruded plastic strips is when the vertical center members are all the same width. Use of four extruded plastic strips is when the vertical center members are selected from two widths. More plastic strips can be used when further variation of door width is desired by selection of the widths of the vertical center members. For example, a door having a width of 12 inches (30.48 cm) is formed with side frame members 30 and 32 having a width of 2¼ inches (5.72 cm), dovetail grooves 52 with a depth of ¼ inch (0.6 cm), outer center members 40 and 46 with a width (exclusive of tongues 64) of 1 inch (2.54 cm) and inner center members 42 and 44 with a width (exclusive of tongues 64) of 3 inches (7.62 cm). In this example, doors made for first extruded strips of 2¼ inches (5.72 cm), third extruded strips of 1 inch (2.54 cm) and fourth extruded strips of 3 inches (7.62 cm) can be made in widths of 9 inches (22.86 cm), 12 inches (30.48), 15 inches (38.1 cm), 18 inches (45.72 cm), etc. by varying the number of inner center members in the door. By varying the number of center members cut from the 1 inch (2.54 cm) width third extruded strip, additional width variations of 1 inch (2.54 cm) can be made in door width. Alternatively, a door having a width of 12 inches (30.48 cm) can be formed with side frame members 30 and 32 having a width of 3¼ inches (8.26 cm), dovetail grooves 52 with a depth of ¼ inch (0.6 cm) and only two center members with a width (exclusive of tongue 64) of 3 inches (7.62 cm). Additional width variation in doors in the alternative example in 3 inch (7.62 cm) increments is made by adding additional center members of 3 inch (7.62 cm) width.

The plastic employed in the extruded strips is any suitable plastic material that can be extruded, has sufficient rigidity and can be provided with or has a finish suitable for cabinet doors. One example is polystyrene but other suitable polymers can be used. The extruded strips can have any color or have a wood-like finish such as that known as faux-wood. For a wood-like finish, a wood-like grain can be produced by adding colored material during extrusion, or the extruded strips can be covered with a film having an imprinted wood-like grain.

Additionally in the variation of FIGS. 4, 9 and 10, there is formed a thin plastic crush strip 70 protruding from the bottom of the grooves 58 in the top and bottom frame members. This plastic crush strip 70 is distorted or bent during assembly of the door so that the ends of the center members are forcefully engaged to prevent any looseness of the center members.

The frame members 30, 32, 34 and 36 can be further secured together by an adhesive (not shown) between the surfaces of the dovetails 62 and the surfaces of the dovetail grooves 52, by power nailing (not shown) or by screws (not shown). Also it is noted that land areas 72 on the faces of the side frame members 30 and 32 and land areas 74 on the faces of the top and bottom frame members 34 and 36 form a common flat rectangular frame around the door.

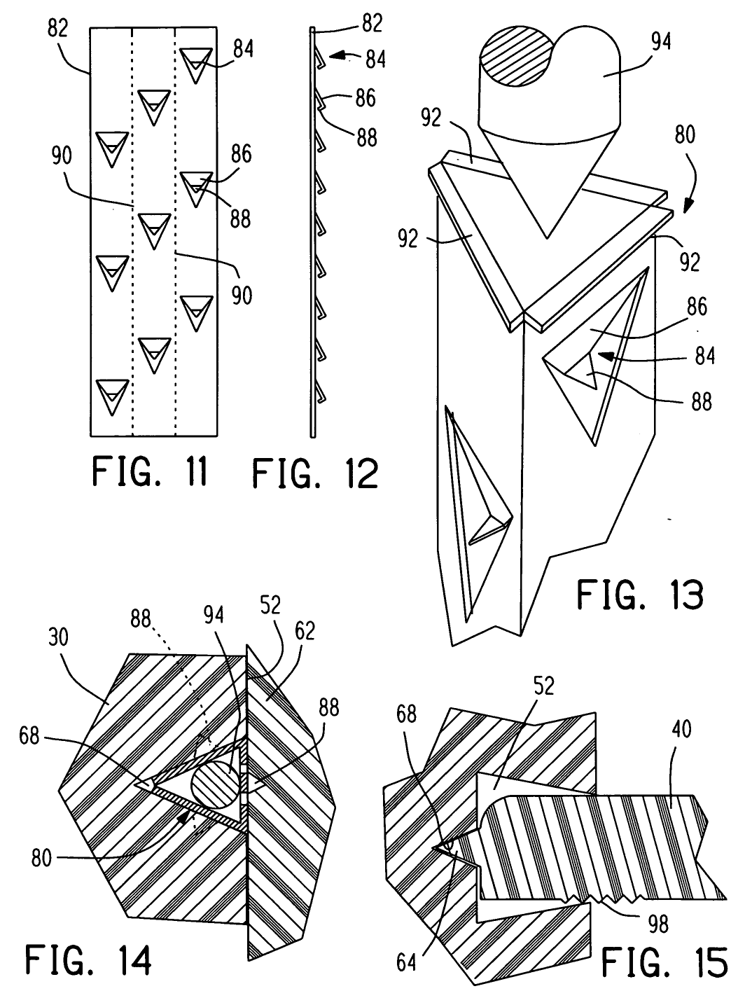

In FIGS. 11, 12, 13 and 14, there is illustrated the formation and employment of a barb member 80 for securing the dovetails 62 within the dovetail grooves 52. A thin sheet metal strip 82 is punched to form three vertical columns of offset triangular barbs 84 with base portions 86 bent to one side and pointed tip portions 88 bent in the opposite direction to a 90° angle with the base portions 86. The metal strip 82 is bent along score lines 90 to form a tubular member of triangular cross section with the barbs 84 inside. This barb member 80 has a size designed to fit into the V-shaped groove 68 in the bottom surface of the dovetail grooves 52. Upper edges 92 of the tubular member 80 are bent outward to form a flange preventing the barb member 80 from falling or being forced past the upper or lower edges of the side members 30 and 32. When a nail 94 having a diameter just fitting in the tubular barb 80 is forced into the tubular barb, the base portions 86 are bent outward so that the pointed tips 88 penetrate into the surfaces of the groove 68 and the dovetail 62 to secure the dovetail in the dovetail groove. In an alternative shown in FIG. 17, a headless screw 96 is screwed into the V-shaped groove 68 to secure the dovetail 62 in the dovetail groove.

In a further variation in shown in FIG. 15, a series of vertical ridges or teeth 98 are formed on the back side of outer center members 40 to adjustably interlock with inward protruding edges of the side frame members at the opening of the dovetail grooves 52.

In a still further variations shown in FIGS. 20 and 21, a crush strip 104 is formed on the bottom of the rectangular groove 68′ of earlier described embodiment of FIG. 18 for engaging the rectangular tongue 64′ or the rounded tongue 64″, FIG. 19, of the vertical center strip 40. Compression, bending etc. of the strip 104 tightens the vertical center members to prevent loose slats or members in the center of the door frame and to accomodate small variations in widths of members and the door.

The cabinet door is attached to a cabinet in a conventional manner such as by hinges (not shown) and knobs or handles (not shown) are attached to the door so that the door can be easily opened.

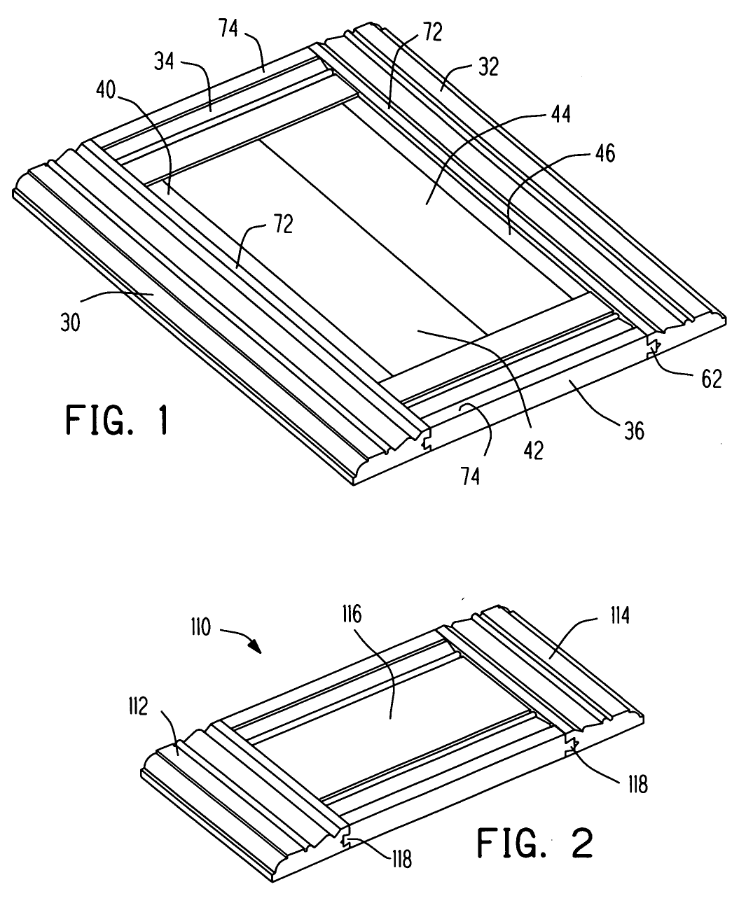

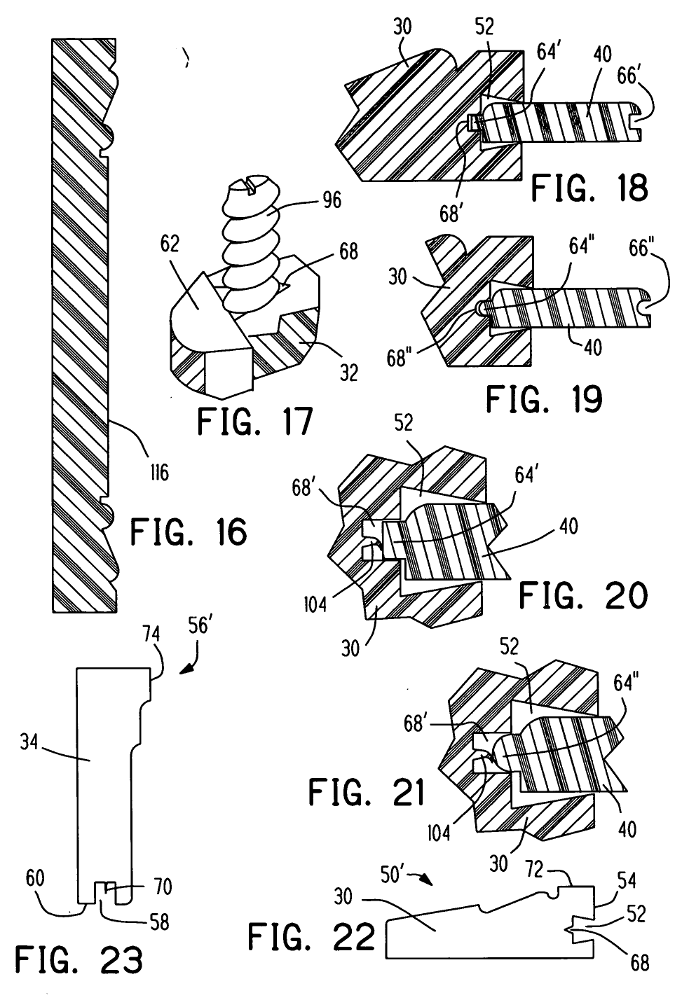

A drawer front 110 is shown in FIG. 2 and has left side member 112, right side member 114 and center member 116. The side members 112 and 114 are cut from the first extruded plastic strip (the same extruded strip used in the side members of the door). The center member 116 is cut from a fifth extruded plastic strip shown in FIG. 16. Dovetails 118 are machined on the ends of the center member 116 and fitted into the dovetail grooves 52 of the side members 112 and 114 to form the drawer front.

In FIGS. 22 and 23, the extruded strip forming the side frame members (only side member 30 is shown) has a profiled face 50′ and the extruded strip forming the top and bottom frame members (only top member 34 is illustrated) has a profiled face 56′. The profiled faces 50′ and 56′ differ from the profiled faces 50 and 56 in FIGS. 3 and 4. Many different profiled faces are possible.

Since many variations, modifications and changes in detail can be made to the above described embodiments, it is intended that the above detailed description and the accompanying drawings be interpreted as only illustrative and not in a limiting sense.

1. A modular plastic cabinet door comprising:
a flame formed by left and right side frame members cut from a first extruded plastic strip and top and bottom frame members cut from a second extruded plastic strip;
said left and right side frame members having opposite orientation and extending the full vertical height of the door with inward facing surfaces having dovetail grooves formed therein;
said top and bottom frame members having opposite orientation with end edges having dovetails fit into the respective upper and lower ends of the dovetail grooves in the side frame members and having facing surfaces with grooves formed therein wherein the grooves have a width equal to a width of the dovetail grooves;
a plurality of vertical center members cut from a third extruded plastic strip wherein the third plastic strip has a thickness equal to the width of the frame member grooves;
said vertical center members having upper and lower ends fit into the grooves of the top and bottom members and having vertical edges with tongues and grooves fitting with each other; and
left and right edge center members of said vertical center members have respective edge portions fit into center portions of the dovetail grooves in the side frame members.

2. A modular plastic cabinet door as claimed in claim 1 wherein the vertical center members include center members cut from a fourth extruded plastic strip having a thickness equal to the width of the frame member grooves; said third and fourth extruded plastic strips having different widths enabling further customization of the door width.

3. A modular plastic cabinet door as claimed in claim 1 wherein the interfitting tongues and grooves of the center members have V-shaped cross sections.

4. A modular plastic cabinet door as claimed in claim 1 wherein the grooves in the top and bottom frame members have crush members extending from bottom surfaces of the grooves throughout the length of the grooves for engaging the ends of the center members.

5. A modular plastic cabinet door as claimed in claim 3 wherein the side members have grooves with a V-shaped cross section formed in the bottom surfaces of the dove-tail grooves to receive a V-shaped tongue member on one of the left and right edge center members.

6. A modular plastic cabinet door as claimed in claim 5 further including metal barb members fit into the V-shaped grooves in the upper and lower ends of the dovetail grooves in the side frame members to engage and secure the dovetails of the top and bottom frame members.

7. A modular plastic cabinet door as claimed in claim 6 wherein the metal barb members are tubular with triangular cross section and have cutouts forming deformable barbs on sides of the barb members; said deformable barbs having pointed tips bent outward so that deformation of the barbs outward by a member inserted into each tubular barb member forces the pointed tips to penetrate into the dovetails and the surfaces of the V-shaped grooves in the dovetail grooves.

8. A modular plastic cabinet door as claimed in claim 5 further including screw members fit into the V-shaped grooves in the upper and lower ends of the dovetail grooves in the side flame members to engage and secure the dovetails of the top and bottom flame members.

9. A modular plastic cabinet door as claimed in claim 1 wherein the interfitting tongues and grooves of the center members have rectangular cross sections and the side members have grooves with a rectangular cross section formed in the bottom surfaces of the dove-tail grooves to receive a rectangular tongue member on one of the left and right edge center members.

10. A modular plastic cabinet door as claimed in claim 9 wherein the wherein the grooves in the dove-tail grooves of the side members have crush members extending from bottom surfaces of the side member grooves for engaging the tongue of the one center member.

11. A modular plastic cabinet door as claimed in claim 1 wherein the interfitting tongues and grooves of the center members have rounded cross sections and the side members have grooves with a rounded cross section formed in the bottom surfaces of the dove-tail grooves to receive a rounded tongue member on one of the left and right edge center members.

12. A modular plastic cabinet door as claimed in claim 1 wherein the interfitting tongues and grooves of the center members have rounded cross sections and the side members have grooves with a rectangular cross section formed in the bottom surfaces of the dove-tail grooves to receive a rounded tongue member on one of the left and right edge center members, and crush members extend from bottom surfaces of the side member grooves for engaging the tongue of the one center members.

13. A modular plastic cabinet door as claimed in claim 1 wherein the at least one outer center member has vertical ridges formed thereon for adjustably interlocking with inward protruding edges of a side member at the opening of the corresponding dovetail groove.

14. A modular plastic cabinet door as claimed in claim 1 wherein the outer center members each have a plurality of vertical ridges formed thereon for adjustably interlocking with inward protruding edges of the corresponding side members at the opening of the corresponding dovetail grooves.

15. A secure dovetail joint comprising:
a first member having a dovetail groove;
a second member having a dovetail fit into the dovetail groove of the first member;
a groove with a V-shaped cross section formed in the bottom surface of the dovetail groove; and
a metal securing member extending in the V-shaped groove for securing the dovetail of the second member in the dovetail groove of the first member.

16. A secure dovetail joint as claimed in claim 15 wherein the metal securing member is a barb member have barbs penetrating into surfaces of the V-shaped groove and the dovetail.

17. A secure dovetail joint as claimed in claim 16 wherein the barb member is tubular and each of the sides of the tubular member have cutouts forming barbs with tips bent outward to penetrate surfaces of the V-shaped groove and the dovetail.

18. A secure dovetail joint as claimed in claim 15 wherein the metal securing member is a screw.

19. A barb member to secure dovetail joints comprising:
an elongated tubular metal member having cutouts formed in the wall of the tubular member to form deformable barbs;
each barb having a base portion bent inward into the tubular member and a pointed tip portion bent outward from the base portion so that the barb member can be inserted into a groove formed between a dovetail and a surface of a dovetail groove receiving the dovetail and then a member can be inserted into the tubular member to bend the base portions of the barbs outward to force the pointed tip portions to penetrate the surfaces of the dovetail and dovetail groove to secure the dovetail in the dovetail groove.
